(19) United States
(12) Patent Application Publication
(10) Pub. No.: US 2026/0148969 A1
(43) Pub. Date: May 28, 2026

(54) COMPOSITE ELECTRODE PARTICLE COATED WITH SILICON LAYER, CARBON LAYER AND ZINC OXIDE

(71) Applicant: ZHI FENG LUO, Shenzhen (CN)

(72) Inventor: ZHI FENG LUO, Shenzhen (CN)

(21) Appl. No.: 18/963,567

(22) Filed: Nov. 28, 2024

(51) Int. Cl. H01M 4/36; H01M 4/02; H01M 4/38; H01M 4/587; H01M 4/62

(52) U.S. Cl. CPC H01M 4/366; H01M 4/386; H01M 4/587; H01M 4/62; H01M 4/625; H01M 4/628; H01M 2004/021; H01M 2004/027

(57) ABSTRACT

A composite electrode particle coated with a silicon layer, a carbon layer and zinc oxide is used in an electrode of a solid-state or semi-solid battery. The composite electrode particle includes a porous carbon particle having a plurality of holes. The silicon layer is coated on an outer surface of the porous carbon particle and is a continuous thin film formed by a silicon material. The carbon layer is an amorphous carbon layer coated on an outer surface of the silicon layer and is a continuous structure formed by amorphous carbon. The amorphous carbon layer serves to inhibit an expansion of the composite electrode particle to prevent the composite electrode particle from rupturing. A zinc oxide layer is coated on an outer side of the amorphous carbon layer and is a continuous structure formed by zinc oxide.

### FIELD OF THE INVENTION

The present invention is related to battery electrode material, and in particular to a composite electrode particle coated with a silicon layer, a carbon layer and zinc oxide.

### BACKGROUND OF THE INVENTION

A typical battery includes a positive electrode and a negative electrode. The negative electrode of a solid-state or semi-solid battery includes a negative electrode substrate and a negative electrode slurry layer. The negative electrode slurry layer includes a negative electrode slurry and a plurality of negative electrode particles. The negative electrode particles must be either additionally conductive or electrically conductive to allow free electrons to migrate through the negative electrode slurry without consuming too much energy due to internal resistance.

The negative electrode particles are dispersed within the negative electrode slurry and an outer surface of each negative electrode particle is coated with silicon particles. In the chemical reaction of the battery, the lithium ions will enter into the silicon particles to expand the size of the silicon particle, wherein the expanded size may be up to 400 times the original size of the silicon particle. Therefore, the size of the negative electrode particles will change dramatically, and such a large size expansion will break down the electrode particles, resulting in a degradation of the battery's performance.

### SUMMARY OF THE INVENTION

Accordingly, for improving above mentioned defects in the prior art, the object of the present invention is to provide a composite electrode particle 40 coated with a silicon layer, a carbon layer and zinc oxide, wherein the silicon layer and the amorphous carbon layer are coated on the outer surface of the porous carbon particle to inhibit the expansion of the composite electrode particle to prevent the composite electrode particle from rupturing. The amorphous carbon layer has a high conductivity and serves to inhibit an expansion of the composite electrode particle to prevent the composite electrode particle from rupturing due to a volumetric expansion when the lithium ions fill on the silicon layer. The outer side of the amorphous carbon layer is further coated with the zinc oxide layer which has metal hardness properties and a high ductility. When the lithium ions fill the silicon layer and expand the size of the silicon layer, the zinc oxide layer serves to protect the structure inside by the high ductility. As a result, by above multi-layer coating structure, the breakage rate of composite electrode particle can be greatly reduced.

To achieve above object, the present invention provides a composite electrode particle coated with a silicon layer, a carbon layer and zinc oxide; the composite electrode particle being used in an electrode of a solid-state or semi-solid battery; the composite electrode particle comprising: a porous carbon particle having a plurality of holes; the silicon layer being coated on an outer surface of the porous carbon particle; the silicon layer being a continuous thin film formed by a silicon material; and the silicon material of the silicon layer being further filled in the holes of the porous carbon particle; the carbon layer being an amorphous carbon layer coated on an outer surface of the silicon layer; the amorphous carbon layer being a continuous structure formed by amorphous carbon; the amorphous carbon layer serving to inhibit an expansion of the composite electrode particle to prevent the composite electrode particle from rupturing due to a volumetric expansion when the lithium ions fill on the silicon layer; and a zinc oxide (ZnO) layer coated on an outer side of the amorphous carbon layer; the zinc oxide layer being a continuous thin film formed by zinc oxide; the zinc oxide layer having a specific conductivity and being a continuous dense layer with metal hardness properties, a specific ductility and integrity.

### BRIEF DESCRIPTION OF THE DRAWINGS

FIG. 1 is a cross-section view showing the structure of the composite electrode particle of the present invention.

FIG. 2 is a schematic view showing the porous carbon particle of the present invention.

FIG. 3 is a schematic view showing the carbon-nanotubes-coated composite electrode particle of the present invention.

FIG. 4 is a schematic view showing an application of the present invention.

FIG. 5 is a schematic view showing another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

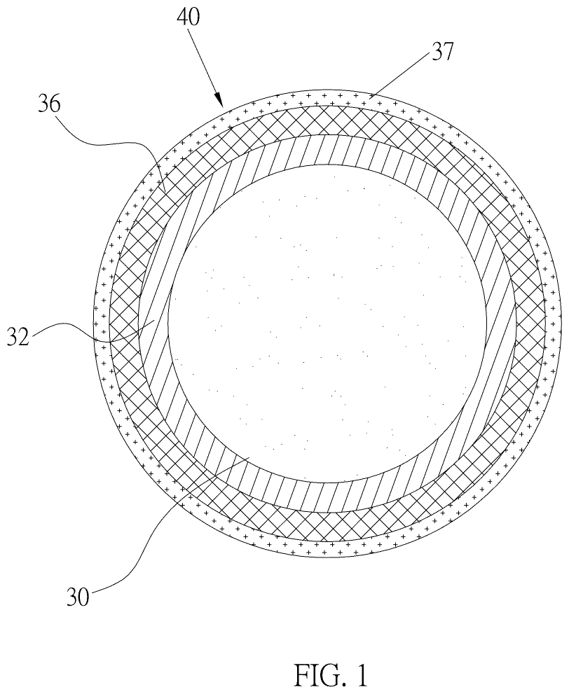

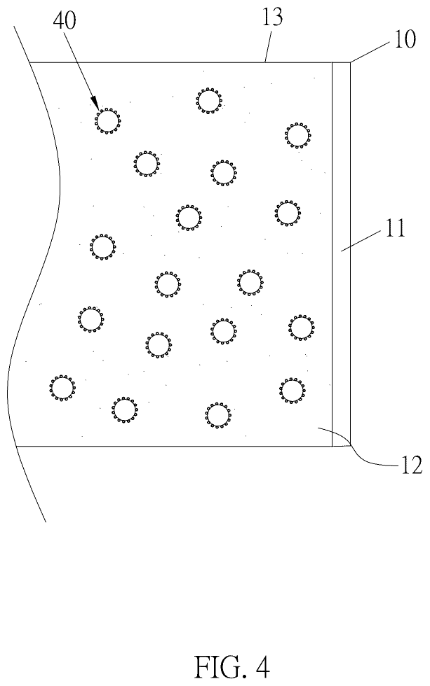

With reference to FIGS. 1 to 5, the present invention provides a composite electrode particle 40 coated with a silicon layer, a carbon layer and zinc oxide, which is used in a negative (−) electrode 10 of a solid-state or semi-solid battery. Referring to FIG. 4, the negative electrode 10 includes a negative electrode substrate 11 for carrying the material of the negative electrode 10, and a negative electrode slurry layer 13 coated on the negative electrode substrate 11. The negative electrode slurry layer 13 includes a plurality of composite electrode particles 40 and a negative electrode slurry 12 having a binder. A weight percentage of the composite electrode particles 40 in the negative electrode slurry layer 13 is 90 wt %˜99 wt %. A size of each of the composite electrode particles 40 is 5 μm to 12 μm.

Referring to FIG. 1, the composite electrode particle 40 includes the following elements.

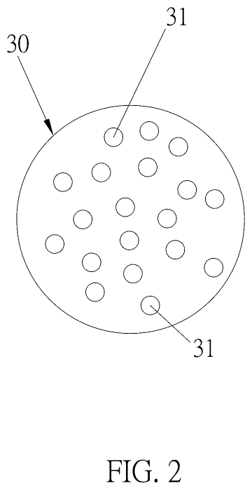

A porous carbon particle 30 has a plurality of holes 31 (as shown in FIG. 2). A size of the porous carbon particle 30 is 5 μm to 10 μm. The porous carbon particle 30 may be formed by graphite.

A silicon layer 32 is coated on an outer surface of the porous carbon particle 30. The silicon layer 32 is a continuous thin film formed by a silicon material. The silicon material of the silicon layer 32 is further filled in the holes 31 of the porous carbon particle 30. A thickness of the silicon layer 32 is less than 15 nm. A ratio of a weight of the silicon layer 32 and a weight of the porous carbon particle 30 is 1:9 to 1:12.

The carbon layer of the present invention is an amorphous carbon layer 36 coated on an outer surface of the silicon layer 32. The amorphous carbon layer 36 is a continuous structure (thin film structure) formed by amorphous carbon. A radial thickness of the amorphous carbon layer 36 is 10 nm to 20 nm. The amorphous carbon layer 36 has a high conductivity and serves to inhibit an expansion of the composite electrode particle 40 to prevent the composite electrode particle 40 from rupturing due to a volumetric expansion when the lithium ions fill on the silicon layer 32. The amorphous carbon of the amorphous carbon layer 36 is selected from hard carbon or soft carbon formed by a de-esterification in sintering of organic resins, and hard carbon or soft carbon formed by a de-esterification in sintering of organic carbohydrates.

In the chemical reaction of the battery, the lithium ions will enter into the silicon layer 32 to expand the size of the silicon layer 32, wherein the expanded size may be up to 400 times the original size of the silicon layer 32. Therefore, the size of the composite electrode particles 40 will change dramatically. In order to prevent composite electrode particle 40 from rupturing due to the expansion of the silicon layer 32, the amorphous carbon layer 36 is coated on the outer surface of the silicon layer 32 to protect the composite electrode particle 40 from rupturing.

A zinc oxide (ZnO) layer 37 is coated on an outer side of the amorphous carbon layer 36. The zinc oxide layer 37 is a continuous thin film formed by zinc oxide. The porous carbon particle 30, the silicon layer 32, the amorphous carbon layer 36 and the zinc oxide layer 37 form the composite electrode particle 40. A radial thickness of the zinc oxide layer 37 is 8 nm to 12 nm. The zinc oxide layer 37 has a high conductivity and is a continuous dense layer with metal hardness properties, a specific high ductility and integrity, which serves to protect the structure inside to keep an integrity of the composite electrode particle 40.

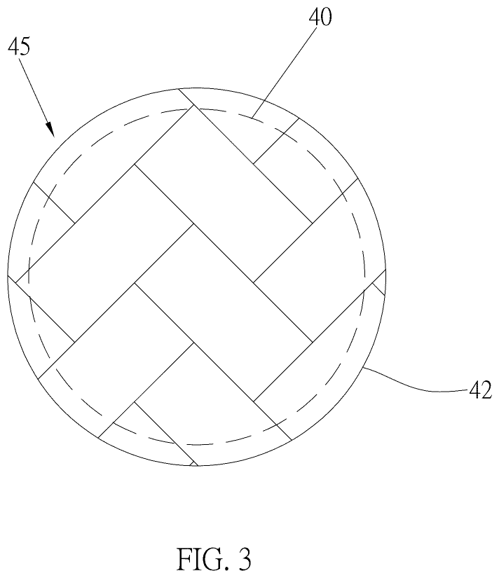

Referring to FIG. 3, an outer side of the composite electrode particle 40 is further wrapped by a plurality of carbon nanotubes 42 to form a carbon-nanotubes-coated composite electrode particle 45. A size of each of the carbon nanotubes 42 is less than 5 μm.

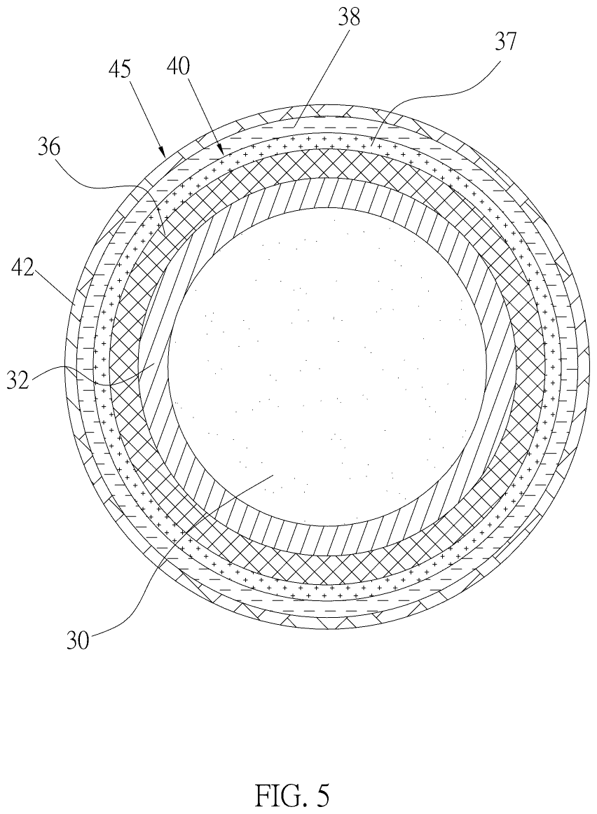

The carbon nanotubes 42 have a high conductivity. The carbon-nanotubes-coated composite electrode particle 45 has a yarn-ball-like structure (as shown in FIG. 5). The carbon nanotubes 42 serve to enhance the electrical conductivity to cause that the electrons can be conducted on the composite electrode particle 40. The carbon nanotubes 42 further serve to conducting the lithium ions to cause that the lithium ions can be conducted between different composite electrode particles 40 in the electrode, which increases the electrical conductivity and ion conductivity of the electrode.

A ratio of a total weight of the carbon nanotubes 42 and a weight of the composite electrode particle 40 is 1:99 to 0.2:99.8.

FIG. 5 shows another embodiment of the present invention, wherein an outer side of the composite electrode particle 40 is coated with an aluminium oxide (Al₂O₃) layer 38. The aluminium oxide layer 38 is a continuous thin film formed by aluminium oxide and is coated on an outer surface of the zinc oxide layer 37 of the composite electrode particle 40. A radial thickness of the aluminium oxide layer 38 is less than 5 nm. The aluminium oxide layer 38 serves to enhance the conductivity and the electrolyte wetting. An outer surface of the aluminium oxide layer 38 is further wrapped by a plurality of carbon nanotubes 42 to form a carbon-nanotubes-coated composite electrode particle 45.

The advantages of the present invention are that the silicon layer and the amorphous carbon layer are coated on the outer surface of the porous carbon particle to inhibit the expansion of the composite electrode particle to prevent the composite electrode particle from rupturing. The amorphous carbon layer has a high conductivity and serves to inhibit an expansion of the composite electrode particle to prevent the composite electrode particle from rupturing due to a volumetric expansion when the lithium ions fill on the silicon layer. The outer side of the amorphous carbon layer is further coated with the zinc oxide layer which has metal hardness properties and a high ductility. When the lithium ions fill the silicon layer and expand the size of the silicon layer, the zinc oxide layer serves to protect the structure inside by the high ductility. As a result, by above multi-layer coating structure, the breakage rate of composite electrode particle can be greatly reduced.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A composite electrode particle coated with a silicon layer, a carbon layer and zinc oxide; the composite electrode particle being used in an electrode of a solid-state or semi-solid battery; the composite electrode particle comprising:
a porous carbon particle having a plurality of holes;
the silicon layer being coated on an outer surface of the porous carbon particle; the silicon layer being a continuous thin film formed by a silicon material; and the silicon material of the silicon layer being further filled in the holes of the porous carbon particle;
the carbon layer being an amorphous carbon layer coated on an outer surface of the silicon layer; the amorphous carbon layer being a continuous structure formed by amorphous carbon; the amorphous carbon layer serving to inhibit an expansion of the composite electrode particle to prevent the composite electrode particle from rupturing due to a volumetric expansion when the lithium ions fill on the silicon layer; and
a zinc oxide (ZnO) layer coated on an outer side of the amorphous carbon layer; the zinc oxide layer being a continuous thin film formed by zinc oxide; the zinc oxide layer having a specific conductivity and being a continuous dense layer with metal hardness properties, a specific ductility and integrity.

2. The composite electrode particle coated with the silicon layer, the carbon layer and the zinc oxide as claimed in claim 1, wherein a size of the porous carbon particle is 5 μm to 10 μm.

3. The composite electrode particle coated with the silicon layer, the carbon layer and the zinc oxide as claimed in claim 1, wherein a thickness of the silicon layer is less than 15 nm.

4. The composite electrode particle coated with the silicon layer, the carbon layer and the zinc oxide as claimed in claim 1, wherein a ratio of a weight of the silicon layer and a weight of the porous carbon particle is 1:9 to 1:12.

5. The composite electrode particle coated with the silicon layer, the carbon layer and the zinc oxide as claimed in claim 1, wherein a radial thickness of the amorphous carbon layer is 10 nm to 20 nm.

6. The composite electrode particle coated with the silicon layer, the carbon layer and the zinc oxide as claimed in claim 1, wherein the amorphous carbon of the amorphous carbon layer is selected from hard carbon or soft carbon formed by a de-esterification in sintering of organic resins, and hard carbon or soft carbon formed by a de-esterification in sintering of organic carbohydrates.

7. The composite electrode particle coated with the silicon layer, the carbon layer and the zinc oxide as claimed in claim 1, wherein a radial thickness of the zinc oxide layer is 8 nm to 12 nm.

8. The composite electrode particle coated with the silicon layer, the carbon layer and the zinc oxide as claimed in claim 1, wherein the composite electrode particle being used in a negative electrode of the solid-state or semi-solid batter.

9. The composite electrode particle coated with the silicon layer, the carbon layer and the zinc oxide as claimed in claim 1, wherein an outer side of the composite electrode particle is further wrapped by a plurality of carbon nanotubes to form a carbon-nanotubes-coated composite electrode particle.

10. The composite electrode particle coated with the silicon layer, the carbon layer and the zinc oxide as claimed in claim 9, wherein a size of each of the carbon nanotubes is less than 5 μm; and the carbon-nanotubes-coated composite electrode particle has a yarn-ball-like structure.

11. The composite electrode particle coated with the silicon layer, the carbon layer and the zinc oxide as claimed in claim 9, wherein a ratio of a total weight of the carbon nanotubes and a weight of the composite electrode particle is 1:99 to 0.2:99.8.

12. The composite electrode particle coated with the silicon layer, the carbon layer and the zinc oxide as claimed in claim 1, wherein an outer side of the composite electrode particle is coated with an aluminium oxide (Al₂O₃) layer; and the aluminium oxide layer is a continuous thin film formed by aluminium oxide and is coated on an outer surface of the zinc oxide layer of the composite electrode particle.

13. The composite electrode particle coated with the silicon layer, the carbon layer and the zinc oxide as claimed in claim 12, wherein a radial thickness of the aluminium oxide layer is less than 5 nm.

14. The composite electrode particle coated with the silicon layer, the carbon layer and the zinc oxide as claimed in claim 12, wherein an outer surface of the aluminium oxide layer is further wrapped by a plurality of carbon nanotubes to form a carbon-nanotubes-coated composite electrode particle.
